(19) United States
(12) Patent Application Publication
(10) Pub. No.: US 2026/0115766 A1
(43) Pub. Date: Apr. 30, 2026

(54) OMNIDIRECTIONAL ACTUATED SURFACES TO DELIVER OBJECTS

(71) Applicant: DISNEY ENTERPRISES, INC., Burbank, CA (US)

(72) Inventors: Lanny S. Smoot, Thousand Oaks, CA (US); Jack Wetherell, Burbank, CA (US); Frank D. Mezzatesta, III, Glendale, CA (US); Robert J. Bristow, Shadow Hills, CA (US)

(21) Appl. No.: 18/930,039

(22) Filed: Oct. 29, 2024

(51) Int. Cl. B07C 5/36; B07C 5/02

(52) U.S. Cl. CPC B07C 5/361; B07C 5/02

(57) ABSTRACT

A system may include an assembly including rotating segments coupled together to induce a motion for an object in contact with the assembly, the assembly including multiple destinations defining areas for delivery. The system may include a controller configured to detect a characteristic of the object, identify a destination of the multiple destinations to deliver the object based on the characteristic, and modify a configuration of the assembly to direct the object to the destination. Additional systems and associated methods are also disclosed.

### FIELD

The present application relates to sorting and routing systems, such as rotating segments coupled together to induce motion for an object on a support surface.

### BACKGROUND

Conventional sorting and routing systems for objects of varied sizes, such as luggage or suitcases at airports, large and small boxes at postal offices, unwrapped objects, and various sized boxes in warehouse order-satisfaction facilities, etc., are complex, difficult to design, and susceptible to clogging. Conventional systems use a complex combination of separate conveyer belts, wheels, rollers, gravity ramps, sorting doors, and/or vehicles to sort and distribute their wares. These systems are difficult to design as they must be able to move objects of different sizes, must accommodate odd-shaped objects without jamming and be able to handle large and heavy objects and small objects that may be fragile. Often, conventional systems only work with objects in uniform packages, such as rectangular boxes of specific sizes. In many cases, when conventional systems break down, objects may lodge in parts of the machinery where it is hard to dislodge them, thus causing delays to restart the system.

Therefore, a need exists for systems and methods that address the deficiencies noted above or at last offers an alternative to existing solutions.

### BRIEF SUMMARY

In one example, a system includes an assembly including rotating segments coupled together to induce a motion for an object in contact with the assembly, the assembly including multiple destinations defining areas for delivery. The system further includes a processor configured to detect a characteristic of the object, identify a destination of the multiple destinations to deliver the object based on the characteristic, and modify a configuration of the assembly to direct the object to the destination.

Optionally, the assembly includes a starting location and a bi-directional path between the starting location and the destination, wherein the processor is configured to direct the object along the bi-directional path via the assembly.

Optionally, the characteristic includes a size of the object, a weight of the object, or an identifier affixed to the object.

Optionally, the system further includes an image system configured to capture an image of the object.

Optionally, the assembly defines multiple paths to the destination, wherein the processor is configured to select a path of the multiple paths based on the characteristic. The multiple paths may be parallel paths.

Optionally, the rotating segments form a flooring or covering surface.

Optionally, the object is a package.

In another example, a delivery system includes a delivery assembly including rotating segments coupled together to induce a motion for an object in contact with the delivery assembly, an image system configured to capture an image of the object, and a controller configured to receive the image, identify a destination to deliver the object based on the image, and modify a configuration of the delivery assembly to direct the object to the destination via the delivery assembly.

Optionally, the delivery assembly defines a receiving area configured to receive multiple objects including the object. The image system may be configured to capture a respective image of the multiple objects. The controller may be configured to identify respective destinations of the multiple objects, with the delivery assembly routing the multiple objects to the respective destinations. The controller may be configured to modify the delivery assembly at the receiving area to separate the multiple objects for detection. The controller may be configured to modify the delivery assembly at the receiving area to orient the multiple objects for image capture.

Optionally, the controller is configured to modify the delivery assembly to direct the object to a different destination based on a user input at the destination.

Optionally, a warehouse includes the delivery system described herein.

Optionally, an assembly line includes the delivery system described herein.

In another example, a method is provided for delivering an object to a destination using a delivery assembly including rotating segments coupled together to induce a motion for the object in contact with the delivery assembly. The method includes detecting a characteristic of the object, identifying the destination to deliver the object based on the characteristic, and modifying a configuration of the delivery assembly to deliver the object to the destination via the delivery assembly.

Optionally, the method includes determining a path along the delivery assembly to route the object to the destination.

Optionally, the method includes separating, via the delivery assembly, multiple objects including the object at a receiving area of the delivery assembly.

Optionally, the method includes reconfiguring the delivery assembly to deliver the object to a different destination based on a user input at the destination.

Optionally, the method includes adapting the delivery assembly based on a detected anomaly of the delivery assembly.

In addition to the exemplary aspects and embodiments described above, further aspects and embodiments will become apparent by reference to the drawings and by study of the following description.

### BRIEF DESCRIPTION OF THE DRAWINGS

FIG. 1 is a schematic illustration of a delivery system.

FIG. 2A illustrates an example delivery system including a delivery assembly formed with a plurality of rotating segments.

FIG. 2B illustrates another example delivery system including a delivery assembly formed with a plurality of rotating segments.

FIG. 3 illustrates an example support surface formed with a plurality of active tiles.

FIG. 4 illustrates an example disk assembly for use in a delivery system.

FIG. 5 illustrates an exploded view of the disk assembly of FIG. 5.

FIG. 6A illustrates a first orientation of a tilted contact disk of the disk assembly of FIG. 4 that defines a first direction a supported object is moved by the disk assembly.

FIG. 6B illustrates a second orientation of a tilted contact disk of the disk assembly of FIG. 4 that defines a second direction a supported object is moved by the disk assembly.

FIG. 6C illustrates a third orientation of a tilted contact disk of the disk assembly of FIG. 4 that defines a third direction a supported object is moved by the disk assembly.

FIG. 6D illustrates a fourth orientation of a tilted contact disk of the disk assembly of FIG. 4 that defines a fourth direction a supported object is moved by the disk assembly.

FIG. 7 illustrates a portion of an active tile including an array of disk assemblies.

FIG. 8 illustrates an example computing system for implementing various examples of the present disclosure.

FIG. 9 illustrates a flow chart providing an example method of delivering an object to a destination using a modular floor.

### DETAILED DESCRIPTION

An omnidirectional actuated surface, such as defined by a modular omnidirectional actuated floor, may be used to deliver or position objects as desired (e.g., on a factory floor, for package or object sorting, etc.). Objects can be placed anywhere on the system's surface and routed to any destination in the system with automatic detection systems (e.g., barcode, QR code, optical recognition, etc.) to determine what the object is and where the object needs to go. The actuated surface may include rotating segments able to move objects in substantially any direction (e.g., backwards, forwards, to the right, to the left, rotating, etc.) and separately from one another. Objects can be moved to avoid one another, uphill or downhill to different distribution levels, or the like. The actuated surface may actively position and orient the objects, such as automatically for object recognition and placement.

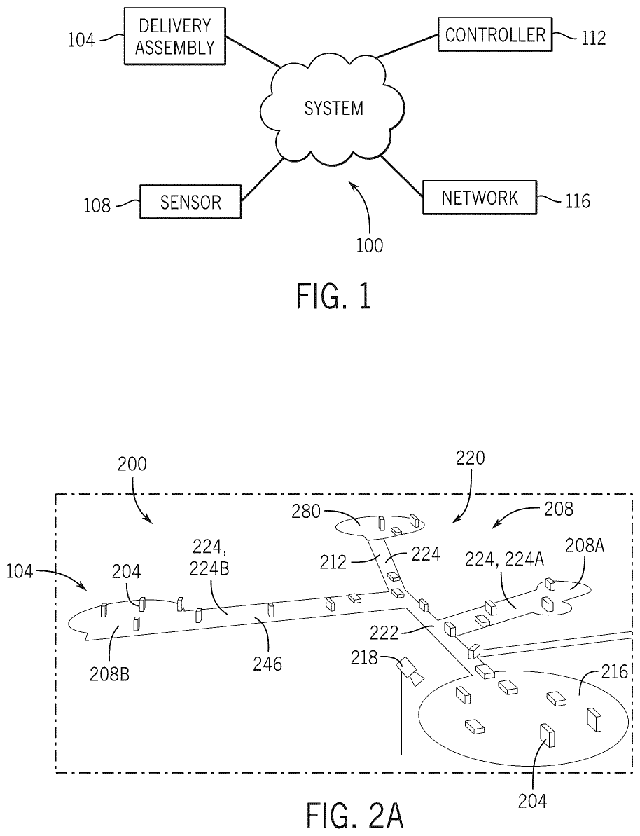

FIG. 1 is a schematic illustration of a delivery system 100. The delivery system 100 may include multiple elements or subsystems that together define a system for delivering or transporting objects from one location to another. For example, the delivery system 100 may deliver packages, containers, palleted goods, or other items between locations (e.g., within a warehouse, a sorting facility, etc.), such as based on detected characteristics of the items (e.g., automatically).

The delivery system 100 may include a delivery assembly 104, a sensor 108, a controller 112, and a network 116. The delivery assembly 104 may be configured to transport or move one or more objects thereon from one location to another. For example, the delivery assembly 104 may include rotating segments that induce or drive movement of the objects, such as to move objects between locations (e.g., to move the objects to a desired location for storage, pick up, delivery, staging, buffer, etc.). As one implementation, the delivery assembly 104 provides a distribution surface (e.g., a flooring or covering surface). Objects can be placed (e.g., anywhere) on the distribution surface and routed to any other location in the system. For instance, barcode and/or quick response (QR) code tracking, optical recognition, or the like may be used to determine what the object is and where the object needs to go (e.g., as supported by stored maps). The delivery assembly 104 may move any, and every, object in any direction (e.g., backwards, forwards, to the right, to the left, etc.) separately, uphill or downhill, around other objects, etc. Not only can the delivery assembly 104 move objects from place to place, in some examples, the delivery assembly 104 may rotate or align the objects (e.g., as the objects are being moved or as a final step before delivery). In this manner, gates and other conventional elements of sorting and routing systems may not be required. For instance, the delivery assembly 104 may move objects to separate destinations without having to use different technologies, such as ramps, rollers, conveyor belts, sorting doors and arms, etc. Separate orientation systems may also not be required.

The sensor 108 may be configured to detect one or more objects on the delivery assembly 104. For example, the sensor 108 may include a barcode scanner, a vision sensor, a camera, a load sensor, or the like to capture characteristics of objects. In some examples, the sensor 108 may detect the object's characteristics automatically, such as using machine vision or other algorithms (e.g., using machine learning, classifiers, image detection, machine assisted inspection, etc.). The object's characteristics may include a size or weight of the object, the position of the object on the delivery assembly 104, a label or identifier affixed to or printed on the object, or other characteristics. Based on the detected characteristics, the delivery system 100 may determine where the objects need to go, such as a destination location, address, or placement. In examples, the delivery assembly 104 may facilitate object detection by the sensor 108. For instance, the delivery assembly 104 may move objects separately to allow barcode or camera readers to view surfaces of the objects. If objects are obscuring other objects, the delivery assembly 104 may pull apart the pile or otherwise spread out the objects to facilitate identification of each object, e.g., activate to introduce space between objections upon an alert or other notification from the system.

The controller 112 may include one or more processors configured to receive and process data or information. For example, the controller 112 may use the visual information or data from the sensor 108 to identify the characteristics of the objects. In some examples, the controller 112 may query a database (e.g., a local database, an online database, a server, etc.), such as to identify the object, access information about the object, or the like. Such information may include a destination of where the object is to be placed or moved, where the object is coming from, a size or weight of the object, etc. In examples, the controller 112 may determine the object's destination based on the object's characteristics themselves, such as using machine learning. The controller 112 may determine a path to route the object to its destination. For example, the controller 112 may calculate a best route for the object from one location to another (e.g., to increase efficiency or throughput of the delivery system 100, to avoid congestion on the delivery assembly 104, to limit travel time or distance, etc.). In calculating the best route or path of the object along the delivery assembly 104, the controller 112 may account for other objects on the delivery assembly 104 and their associated paths or routes. For instance, the controller 112 may coordinate the movement of multiple objects along the delivery assembly 104, such as simultaneous movement of the multiple objects to the same or varying destinations.

The network 116 may facilitate communications between various components of the delivery system 100. For example, the network 116 may include hardware, software, or both providing one or more interfaces for communication (such as, for example, packet-based communication) between delivery assembly 104, sensor 108, and controller 112, or other components of the delivery system 100 (e.g., one or more computer systems, sensors, or devices). The network 116 may include a modem, Ethernet card, a network interface controller (NIC) or network adapter for communicating with an Ethernet or other wire-based network, a wireless NIC (WNIC) or wireless adapter for communicating with a wireless network, such as a WI-FI network.

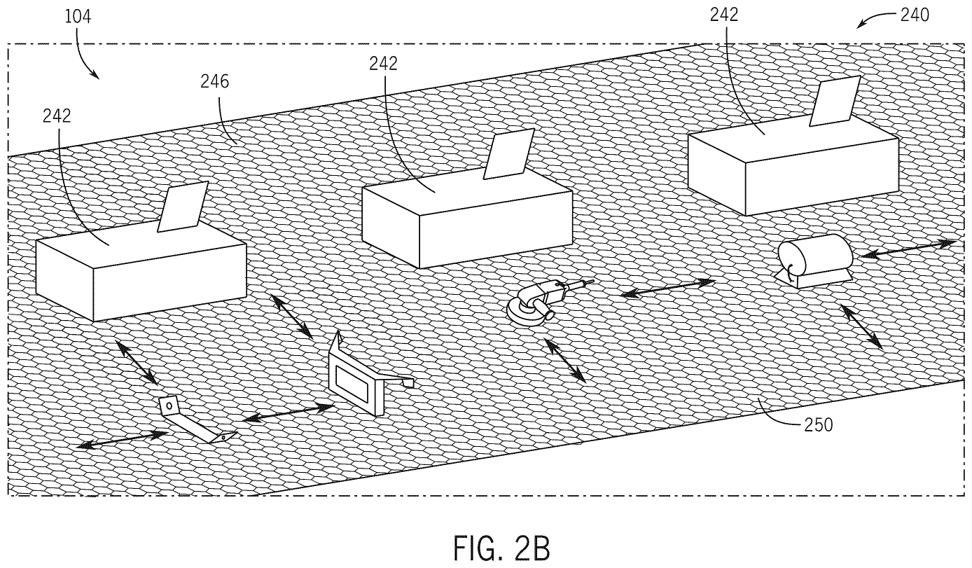

FIG. 2A illustrates an example implementation of the delivery system 100. As shown, the delivery system 100 may be implemented as a package delivery system 200. For example, the delivery assembly 104 may be implemented to deliver one or more packages or objects 204 to various destinations, such as within a warehouse or package sorting facility (e.g., postal service location, baggage sorting facility at airports, etc.). The delivery assembly 104 may include multiple destinations 208 defining areas for delivery (e.g., a first destination 208A defining a first area for delivering objects 204, a second destination 208B defining a second area for delivering objects 204, and so on). Depending on the application, the destinations 208 may be on the same level or at different levels within the warehouse or package sorting facility. For example, the delivery assembly 104 may include ramps 212 configured to move objects 204 between different levels. The destinations 208 may define areas for holding multiple objects 204, such as staging or holding areas configured to store multiple objects 204 at the same time.

In examples, the delivery assembly 104 may include a starting location 216 and an image system 218. The starting location 216 may be a receiving area (e.g., drop off location) configured to receive and begin sorting multiple objects 204. The delivery assembly 104 may pull apart piles of objects 204 placed at the starting location 216, such as using rotating segments that actively spread out the objects 204, such as to facilitate identification of the objects 204 using the image system 218. For example, the controller 112 may be configured to modify the delivery assembly 104 at the starting location 216 or receiving area to separate multiple objects 204 for detection. Additionally, or alternatively, the controller 112 may be configured to modify the delivery assembly 104 at the starting location 216 or receiving area to orient the multiple objects 204 for image capture (e.g., by image system 218).

The image system 218 may be configured to capture images of respective objects 204. For example, the image system 218 may include sensor 108, described above, for detecting characteristics of the object 204 at the starting location 216. In some examples, the image system 218 may include additional sensors at each destination 208 and/or other areas of the delivery assembly 104. In such examples, the image system 218 may be configured to observe where the objects 204 are and/or facilitate route calculation (e.g., to detect congestion or other route anomalies).

The delivery assembly 104 may include one or more routes 220 between the starting location 216 and the various destinations 208. The routes 220 may include a central route 222 and one or more branches 224 extending from the central route 222 to the destinations 208 (e.g., a first branch 224A between the central route 222 and the first destination 208A, a second branch 224B between the central route 222 and the second destination 208B, and so on). The routes 220 or paths may be bi-directional. For example, the delivery assembly 104 may include rotating segments that actively move objects 204 in any direction along the routes 220 (e.g., to the destinations 208, away from the destinations 208, etc.).

A controller (e.g., the controller 112) of the delivery system 200 may be configured to detect a characteristic of a respective object 204 at a location (e.g., at the starting location 216), identify a destination 208 of the multiple destinations 208 to deliver the object 204 based on the detected characteristic, and modify a configuration of the delivery assembly 104 to direct the object 204 to the destination 208. The detected characteristic may be a size of the object 204, a weight of the object 204, or an identifier affixed to the object 204. For example, the detected characteristic may include a barcode, a QR code, or a visual identifier associated with the object 204, such as detectable in the images captured by the image system 218 and received by the controller 112, that identifies or indicates a destination 208 for the object 204. Based on the detected object characteristic, the controller 112 may determine which of the first destination 208A, the second destination 208B, or other destination 208 to deliver the object 204, such as based on similar sizing, weight, delivery address, customer, baggage for travel (e.g., flight, cruise, train, etc.), etc. To deliver the object 204 to its destination 208, the controller 112 may modify a configuration of the delivery assembly 104, such as driving rotating segments of the delivery assembly 104 to actively move the object 204 to its destination 208. For example, the controller 112 may be configured to direct the object 204 along the bi-directional routes 220 or paths via the delivery assembly 104.

In some examples, the delivery assembly 104 may define multiple paths to the same destination 208. For example, multiple paths or branches 224 may extend to the same destination 208, such as for redundancy or efficiency. In examples, a single route or branch may include multiple paths, such as parallel paths. For instance, the delivery assembly 104 may allow objects 204 to pass by each other along the same route or branch. In such examples, the delivery assembly 104 may adjust dynamically to allow multiple objects 204 to travel along the same route or path, such as at different speeds and/or along different directions. The controller 112 may be configured to select a path of the multiple paths based on the characteristic of the object 204. For example, one path of the multiple paths may be configured to carry heavy loads, another path of the multiple paths may be configured to move fragile items, and yet another path of the multiple paths may be configured for express transport.

In examples, the objects 204 may switch between paths, such as based on priority, congestion along one path, an anomaly along the path or paths, or the like, so as to maintain efficient operations. In this manner, the delivery system 200 may dynamically adjust based on current conditions, such as routing the objects 204 around congestion, adjusting the routing based on demand, adjusting the routing based on changes in destination 208 (e.g., updated travel information), etc.

In some examples, the delivery assembly 104 may move one or more objects 204 based on user input. For instance, the controller 112 may be configured to modify the delivery assembly 104 to direct objects 204 to different destinations 208 based on user input at an initial destination 208. As one example, user input at an initial or intermediate destination 208 for an object 204 may indicate that the object 204 is not desired (e.g., not what was requested, damaged goods, otherwise rejected, etc.). In such examples, the delivery assembly 104 may direct the rejected object 204 to a different destination 208, such as back to the starting location 216, to a staging area for further inspection, etc.

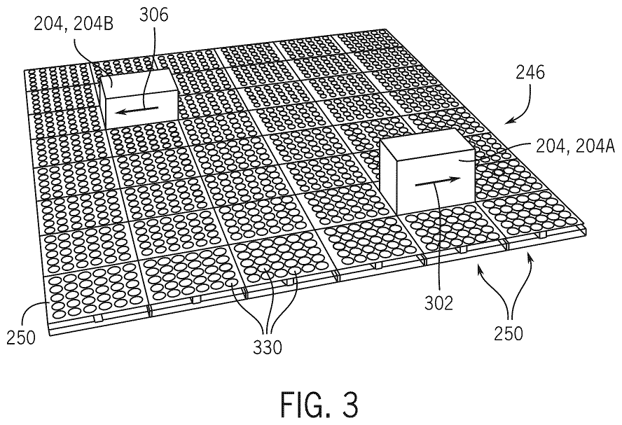

FIG. 2B illustrates another example implementation of the delivery system 100. As shown, the delivery system 100 may be implemented as an assembly line 240 (e.g., a factory floor). For example, the delivery assembly 104 may be implemented to deliver parts, assemblies, or tooling to separate work stations 242 along the assembly line 240 or factory floor. Thus, the objects 204 movable by the delivery assembly 104 are not limited to any particular implementation. For example, the delivery assembly 104 may move a part assembly down the line while simultaneously delivering parts and tooling to the work stations 242, when needed. If an anomaly occurs during assembly, the delivery assembly 104 may adjust the assembly line 240 accordingly. For instance, the delivery assembly 104 may move assemblies, parts, or even work stations 242 or machinery off the line, such as for replacement and/or to continue operations with other assemblies and work stations 242, such as automatically based on changing conditions. This allows the factory floor to adapt to conditions, such as component shortages, tool failure, load balancing needs, employee skill level, quality assurance or rework, and the like, such as improved over linear assembly line style factory architectures. Although FIGS. 2A, 2B, and 3 illustrate the delivery system 100 implemented in a warehouse and/or assembly line 240, other configurations are contemplated, and as such, the illustrated implementations are exemplary only, without intent to limit.

Referring to FIGS. 2A, 2B, and 3, the delivery assembly 104 may include a support surface 246 to facilitate movement of the objects 204 between the various destinations 208 and areas. Depending on the application, the support surface 246 may define a flooring or covering surface. The support surface 246 may be defined by a plurality of tiles 250 connected together. For example, any number of tiles 250 may be clipped, connected, or secured together to define a desired size or dimension of the support surface 246, such as based on warehouse size or configuration, the particular package sorting environment, etc. In that sense, the support surface 246 may define at least a portion of a warehouse floor.

The tiles 250 may include rotating segments configured to move independently to induce a motion for the objects 204 in contact with the support surface 246, such as selectively actuated to move the objects 204 to their destinations 208. For example, the support surface 246 may define an infinitely adjustable path for the objects 204 to move. For instance, the objects 204 may be moved by the support surface 246 in any direction, thereby providing unique configurations and possibilities for package sorting and object delivery. For example, the support surface 246 may move the object 204 in linear directions and/or rotational directions. The objects 204 may be moved by the support surface 246 independent from one another. For example, multiple objects 204 may be moved in the same or different directions to deliver the objects 204 to their respective destinations 208.

FIG. 3 illustrates an example support surface 246 formed with a plurality of active tiles 250 (e.g., rotating segments). The tiles 250 may include the same or similar shape, such that multiple tiles 250 may be connected together to form the support surface 246. The tiles 250 may be of any shape that by repetition can cover a surface without substantial gaps. For example, the tiles 250 may include a shape that allows multiple tiles 250 to be connected together to form an integrated surface of the support surface 246. For instance, the tiles 250 may include a polygonal shape of any closed plane figure bounded by three or more line segments, such as three line segments defining a triangular shape, four line segments defining a quadrilateral shape, or more than four line segments defining another polygonal shape (e.g., six line segments defining a hexagonal shape, among other suitable shapes). In other examples, the tiles 250 may have curved edges that still mesh to create a contiguous surface. In such examples, any number of tiles 250 may be connected together to define the support surface 246 of a desired size and shape. The various tiles 250 may be coupled together (e.g., via interlocking or coupling features) or the tiles 250 may be positioned adjacent one another to define the support surface 246.

As described herein, the support surface 246 includes rotating segments coupled together to induce, provide or facilitate motion of one or more objects 204 (e.g., packages, luggage, baggage, containers, platforms, parts, tools, wares, goods, or any other object placed or positioned on the support surface 246) on the support surface 246. For instance, the rotating segments or elements may move one or more objects 204 across the support surface 246, such as from a first location to a second location on the support surface 246.

In one example, the support surface 246 may support independent movement of multiple (e.g., two or more) objects 204. For instance, as shown, the support surface 246 may move a first object 204A along a first direction 302, and a second object 204B along a second direction 306 that differs from the first direction 302. The directions 302, 306 may be independent and concurrent, even while different in the example illustrated. In some examples, the support surface 246 may be configured to move or facilitate movement of an object 204 in any direction (e.g., any lateral or rotational direction across the support surface 246), such that the support surface 246 may be considered an omnidirectional actuated floor.

The motion control described herein may be provided by one or more disk assemblies 330 of the delivery assembly 104. As shown, each tile 250 may include one or more disk assemblies 330, such as a plurality of disk assemblies 330. In such examples, the disk assemblies 330 may support the one or more objects 204 on the support surface 246. The disk assemblies 330 may be operated to move the objects 204 on the support surface 246, such as in a manner as described herein. For example, the disk assemblies 330 may engage the objects 204 so as to move the objects 204 as the disk assemblies 330 are operated, as described herein.

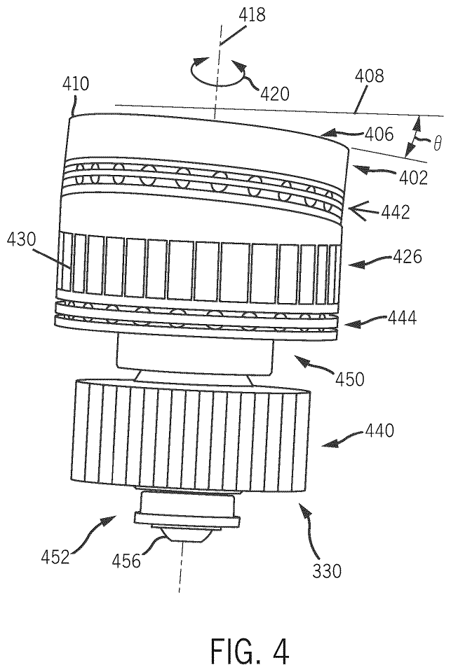

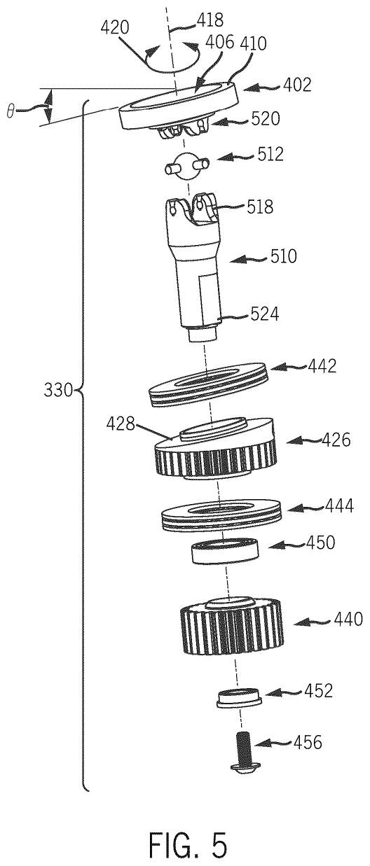

FIG. 4 illustrates an example disk assembly 330 for use in a system of the present description (e.g., delivery system 100/200/240, delivery assembly 104, described above), such as with a plurality of other disk assemblies 330 in an active tile 250. FIG. 5 illustrates an exploded view of the disk assembly 330. The disk assembly 330 may include a contact disk 402. The contact disk 402 may be at a first end (e.g., an outer or exposed end) of the disk assembly 330 and includes an upper surface 406. In one example, the upper surface 406 may be used in the support surface 246 described herein, such as with a plurality of other surfaces to support and move an object 204. The contact disk 402 may be positioned and/or supported in the disk assembly 330 so as to place the upper surface 406 at a tilt angle θ, such as relative to the plane 408 of the active tile 250. In one example, the upper surface 406 may include a contact surface 410 defined by a raised segment or edge relative to the rest of the upper surface 406. In such examples, the contact surface 410 (along with similar segments/portions of other contact disks in an active tile 250) may contact and support an object 204 placed on the disk assembly 330. The tilt angle θ may be an angle of 5 to 60 degrees, with about 8 to 15 degrees being useful in some examples, and about 10 degrees (e.g., 9.5 to 10.5 degrees) being useful in one implementation.

During use, the contact disk 402 may be rotated about a rotation axis 418, such as through a rotation 420. As shown, the rotation axis 418 extends at a non-orthogonal angle to the plane of the upper surface 406. In this manner, the contact surface 410 of the contact disk 402 may be positioned at a predefined location relative to the rotation axis 418 during operation of the disk assembly 330, such as to move a supported object 204 in a desired direction, as described herein. For example, the disk assembly 330 may include a swashplate 426 provided with an angled or tilted surface 428 to support the contact disk 402 at the tilt angle θ. The swashplate 426 may be drivable to selectively change where the contact surface 410 is located relative to the rotation axis 418. For instance, the swashplate 426 may be drivable via outer teeth 430 as shown in FIG. 4, be belt driven, or the like. In such examples, selective positioning of the contact surface 410 via rotation of the swashplate 426 may control which direction a supported object 204 is moved. In one example, the swashplate 426 may remain stationary or fixed in place relative to the rotation axis 418 during the rotation 420 of the contact disk 402.

The disk assembly 330 may include various drive components and bearings to support and to facilitate rotation of the contact disk 402 under load. For example, the disk assembly 330 may include a gear 440 for rotating the contact disk 402 about the rotation axis 418, as detailed herein. A first thrust bearing 442 may be positioned between the contact disk 402 and the swashplate 426, such as to reduce friction between the contact disk 402 and the swashplate 426. A second thrust bearing 444 may be positioned between the swashplate 426 and the gear 440, such as to reduce friction between the swashplate 426 and the gear 440. The first and second thrust bearings 442, 444 may be configured to transfer a load on the contact disk 402 downward into the disk assembly 330 (e.g., into the stack of components of the disk assembly 330). For instance, the first thrust bearing 442 may transfer a downward load from the contact disk 402 onto the swashplate 426, and the second thrust bearing 444 may transfer the downward load from the swashplate 426 onto the gear 440. In some examples, the disk assembly 330 may include a top bearing 450 and a bottom bearing 452, such as for the purposes described below. A fastener 456 may secure the components of the disk assembly 330 together as an operable unit.

Referring to FIG. 5, the disk assembly 330 may include a drive shaft 510. The drive shaft 510 may be coupled to the contact disk 402 and driven by the gear 440. For instance, the disk assembly 330 may include a U-joint 512 pivotally coupled to both an end 518 of the drive shaft 510 and an underside 520 of the contact disk 402. The U-joint 512 may allow the contact disk 402 to be rotated while the high-point or contact surface 410 of the contact disk 402 is turned or redirected via the swashplate 426 to change the tilt direction or disk orientation of the contact disk 402 (e.g., to change the location of the contact surface 410 relative to the rotation axis 418). The drive shaft 510 may be coupled to the gear 440 (e.g., via a keyed engagement 524) such that rotation of the gear 440 rotates the drive shaft 510. In such examples, rotation of the gear 440 causes the drive shaft 510 to rotate, which, in turn, causes the contact disk 402 to rotate about the rotation axis 418. With continued reference to FIG. 5, the top and bottom bearings 450, 452 may rotationally support the drive shaft 510, such as centering the drive shaft 510 within the disk assembly 330.

According to various examples described herein, the contact disk 402 is supported at the tilt angle θ by the tilted surface 428 of the swashplate 426 and then selectively rotated (e.g., rotation 420) about the rotation axis 418 while the swashplate 426 remains stationary, such as to move an object 204 supported upon the contact surface 410 of the upper surface 406. Rotation 420 may be provided through a disk rotation mechanism (which includes at least the gear 440) in the disk assembly 330 that works in combination with a drive system (not shown in FIGS. 4-5) (e.g., one or more motors driving belts, screw drives, gears, or the like to impart motion on one or more components of the disk rotation mechanism such as upon the outer teeth 430 of the gear 440).

The upper surface 406 is circular in shape in the illustrated embodiment, with the contact surface 410 being an outer ring-shaped surface or lip configured to engage surfaces of a supported object 204. The contact disk 402 is positioned or supported at the disk or tilt angle θ (e.g., an angle in the range of 5 to 60 degrees or the like as measured between a horizontal plane and the upper surface 406 of the contact disk 402). Such configurations cause a raised edge or portion of the contact surface 410 to contact and move an object 204 (e.g., a package, a vehicle, a container, or any other object) supported upon the contact disk 402. The raised edge/segment may be a fraction of the contact surface 410, such as in the range of 1/10 to ⅔ of the available surface, depending on the magnitude of the tilt angle θ.

Each disk assembly 330 may be adapted to allow the contact disk 402 to be oriented as desired to set the location of the contact surface 410 relative to the rotation axis 418. For instance, the contact disk 402 may be rotated relative to the rotation axis 418, such as by rotation of the swashplate 426 about the rotation axis 418, to orient the contact disk 402 relative to the rotation axis 418, as described above. In such examples, the orientation of the contact surface 410 relative to the rotation axis 418 may define the direction a supported object 204 is moved by the disk assembly 330.

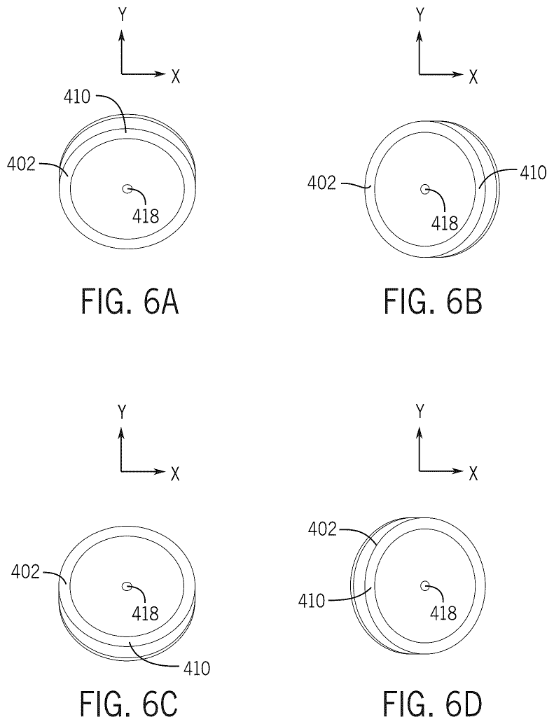

For example, FIGS. 6A-6D illustrate various orientations of the contact disk 402 that define respective directions a supported object 204 is moved by the disk assembly 330. Referring to FIG. 6A, the tilt direction or disk orientation of the contact disk 402 may be set with the contact surface 410 at the “top” of the contact disk 402 (when looking at the page containing FIG. 6A). If the contact disk 402 is rotated clockwise about the rotation axis 418, a supported object 204 may be moved in a positive X direction or to the right when looking at the page containing FIG. 6A. Conversely, if the contact disk 402 is rotated counterclockwise about the rotation axis 418, the supported object 204 may be moved in a negative X direction or the left when looking at the page containing FIG. 6A.

Referring to FIG. 6B, the tilt direction or disk orientation of the contact disk 402 may be set with the contact surface 410 at the “right” of the contact disk 402 (when looking at the page containing FIG. 6B). If the contact disk 402 is rotated clockwise about the rotation axis 418, a supported object 204 may be moved in a negative Y direction or downwards when looking at the page containing FIG. 6B. Conversely, if the contact disk 402 is rotated counterclockwise about the rotation axis 418, the supported object 204 may be moved in a positive Y direction or upwards when looking at the page containing FIG. 6B.

Referring to FIG. 6C, the tilt direction or disk orientation of the contact disk 402 may be set with the contact surface 410 at the “bottom” of the contact disk 402 (when looking at the page containing FIG. 6C). If the contact disk 402 is rotated clockwise about the rotation axis 418, a supported object 204 may be moved in a negative X direction or to the left when looking at the page containing FIG. 6C. Conversely, if the contact disk 402 is rotated counterclockwise about the rotation axis 418, the supported object 204 may be moved in a positive X direction or the right when looking at the page containing FIG. 6C.

Referring to FIG. 6D, the tilt direction or disk orientation of the contact disk 402 may be set with the contact surface 410 at the “left” of the contact disk 402 (when looking at the page containing FIG. 6D). If the contact disk 402 is rotated clockwise about the rotation axis 418, a supported object 204 may be moved in a positive Y direction or upwards when looking at the page containing FIG. 6D. Conversely, if the contact disk 402 is rotated counterclockwise about the rotation axis 418, the supported object 204 may be moved in a negative Y direction or downwards when looking at the page containing FIG. 6D.

During any particular operation period used to move an object 204 in a particular direction, the components of the disk assembly 330 may be configured to allow the contact disk 402 to be oriented in any of the four orientations or disk directions illustrated in FIGS. 6A-6D (or to any intermediate position between these four orientations) and to concurrently allow the contact disk 402 to be rotated at a desired rate or speed about the rotation axis 418, while remaining at the tilt angle θ at the particular disk face orientation/direction. As a result, the disk assemblies 330 may move an object 204 along any direction across the support surface 246. In this manner, the disk assemblies 330 may define an omnidirectional actuated floor.

Arrays or pluralities of the disk assemblies 330 may be combined into a single tile 250, and multiple tiles 250 may be combined to provide the support surface 246 described herein, or can be used in combination to provide a large floor or platform to move supported objects 204. In such embodiments, each drive assembly may be driven independently; however, it may be useful in some embodiments to concurrently drive an array or subset of the disk assemblies 330 used to make up a support floor/platform, such as by orienting and driving/rotating each contact disk 402 in an active tile 250 similarly (e.g., drive each drive assembly in an active tile 250 concurrently and similarly to move an object 204 on the tile 250 in a particular direction and at a particular speed).

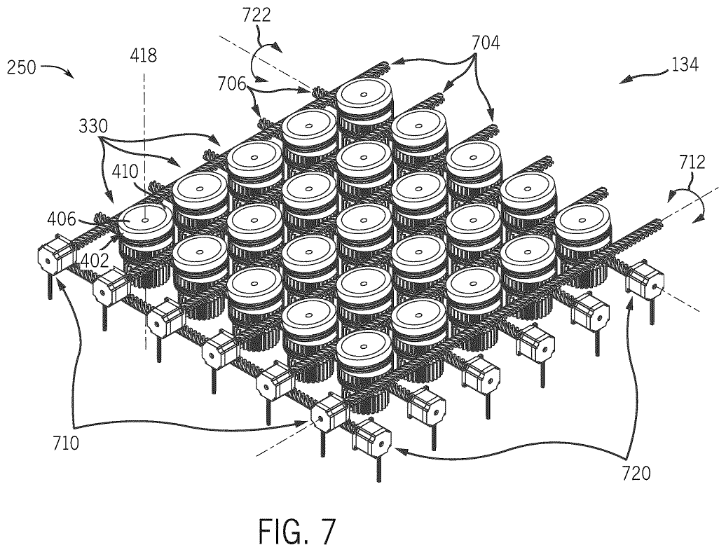

Accordingly, FIG. 7 illustrates a portion of an active tile 250 including an array or plurality of disk assemblies 330. Referring to FIG. 7, an array or plurality of disk assemblies 330 may be arranged in a pattern. For example, multiple disk assemblies 330 may be arranged in a rectangular pattern of parallel rows and columns, although other configurations are contemplated. The disk assemblies 330 may include parallel rotation axes (e.g., rotation axis 418 of each disk assembly 330 may be parallel), with the upper surfaces 406 facing a single direction. For example, each contact disk 402 may be oriented to have the same disk direction or to have its tilt angle oriented in the same way. The disk assemblies 330 may be driven together as a set or concurrently to rotate at the same rate and in the same direction about their rotation axes. In this manner, the plurality of disk assemblies 330 (or a subset of the disk assemblies 330) may move an object 204 supported thereon in the same direction and at the same rate.

In the embodiment shown in FIG. 7, first lead screws 704 are positioned to contact the outer teeth 430 of each swashplate 426, and second lead screws 706 are positioned to contact the geared/toothed outer surface of each gear 440. One or more drive motors 710 may be selectively controlled to rotate the first lead screws 704 in a direction of rotation 712 as needed/desired to set the tilt direction or disk orientation of each contact disk 402 (e.g., to orient the contact disks 402 by rotating the swashplates 426 about their respective rotation axis 418), such as to position raised edges of the contact disks 402 concurrently in a desired location. Stated differently, rotation of the first lead screws 704 by the drive motors may cause the swashplates 426 to rotate about their respective rotation axes, which, in turn, causes the supported contact disks 402 to likewise rotate to position the contact surfaces 410 at a new location.

Concurrently or at a different time, one or more spin motors 720 may be selectively controlled to rotate the second lead screws 706, thereby driving the gears 440 to rotate (e.g., at the same rate). Rotation of the gears 440 may cause the contact disks 402 to rotate, with the direction of rotation of the contact disks 402 set by a direction of rotation 722 of the second lead screws 706. Similarly, the rate of rotation of the contact disks 402 may be set by a rate of rotation of the second lead screws 706 in the direction of rotation 722.

Such examples are illustrative only, and the support surface 246 may be operated using other systems and configurations. For instance, the contact disks 402 may be rotated via intermeshing gears, among other examples. In some examples, one or more (e.g., each) contact disks 402 may be rotated via a gear train including multiple gears. In such examples, one or more motors (e.g., drive motors 710 and/or spin motors 720) may be selectively controlled to rotate the gears, thereby causing the contact disks 402 to rotate.

The embodiments illustrated in FIGS. 3-7 are non-limiting examples for providing a motion system including a modular floor formed with a plurality of active tiles (e.g., tiles 250), the active tiles having one or more disk assemblies with a rotatable, angled disk and with mechanisms for rotating/spinning the disk and for orienting the disk to have its raised edge/portion in a desired location to direct a supported object 204 in a desired direction during disk rotation. Thus, the delivery assembly 104, support surface 246, active tiles 250, and disk assemblies 330, described above, are illustrative only, and other configurations are contemplated. In one example, the systems and elements described herein (e.g., the tiles 250 and disk assemblies 330) may be similar to those described in U.S. patent application Ser. No. 15/790,124, now U.S. Pat. No. 10,416,754 B2, and U.S. patent application Ser. No. 16/135,952, now U.S. Pat. No. 10,732,197 B2, the disclosures of which are hereby incorporated by reference for all purposes.

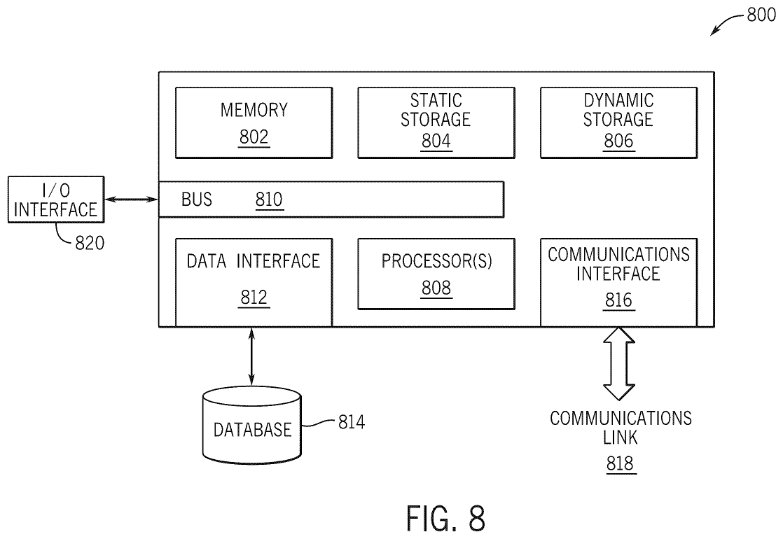

FIG. 8 illustrates an example computing system 800 for implementing various examples described herein. For example, in various embodiments, components of the delivery system 100 or other systems described herein may be implemented by one or several computing systems 800. This disclosure contemplates any suitable number of computing systems 800. For example, the computing system 800 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 800 may include one or more computing systems; be unitary or distributed; span multiple locations; span multiple machines; span multiple data centers; or reside in a cloud, which may include one or more cloud components in one or more networks (e.g., network 116).

Computing system 800 includes a bus 810 (e.g., an address bus and a data bus) or other communication mechanism for communicating information, which interconnects subsystems and devices, such as processor 808, memory 802 (e.g., RAM), static storage 804 (e.g., ROM), dynamic storage 806 (e.g., magnetic or optical), communications interface 816 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 820 (e.g., keyboard, keypad, mouse, microphone, display). In particular embodiments, the computing system 800 may include one or more of any such components.

In particular embodiments, processor 808 includes hardware for executing instructions, such as those making up a computer program. For example, processor 808 may execute instructions for various components of the delivery system 100/200/240, delivery assembly 104 or other systems described herein (e.g., the controller 112). The processor 808 circuity includes circuitry for performing various processing functions, such as executing specific software to perform specific calculations or tasks. In particular embodiments, I/O interface 820 includes hardware, software, or both, providing one or more interfaces for communication between computing system 800 and one or more I/O devices. Computing system 800 may include one or more of these I/O devices, where appropriate. One or more of these I/O devices may enable communication between a person and computing system 800.

In particular embodiments, the communications interface 816 includes hardware, software, or both providing one or more interfaces for communication (such as, for example, packet-based communication) between computing system 800 and one or more other computer systems or one or more networks (e.g., network 116). One or more memory buses (which may each include an address bus and a data bus) may couple processor 808 to memory 802. Bus 810 may include one or more memory buses, as described below. In particular embodiments, one or more memory management units (MMUs) reside between processor 808 and memory 802 and facilitate accesses to memory 802 requested by processor 808. In particular embodiments, bus 810 includes hardware, software, or both coupling components of computing system 800 to each other.

According to particular embodiments, computing system 800 performs specific operations by processor 808 executing one or more sequences of one or more instructions contained in memory 802. For example, instructions for the delivery system 100, the delivery assembly 104 or other systems described herein (e.g., to perform the operations described above) may be contained in memory 802 and may be executed by the processor 808. For example, the processor 808 may be configured to modify a configuration of the support surface 246 to move objects 204 to intended destinations 208, as described herein. In examples, the processor 808 may be configured to modify a configuration of the delivery system 100 based on sensory input (e.g., based on a detected orientation, position, or movement of the objects 204 on the support surface 246). In such examples, the processor 808 may be in communication with the sensor 108. Based on the detected orientation, position, or movement of the objects 204, the processor 808 may adjust the delivery assembly 104, such as adjusting the support surface 246.

Such instructions may be read into memory 802 from another computer readable/usable medium, such as static storage 804 or dynamic storage 806. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 808 for execution. Such a medium may take many forms, including but not limited to, nonvolatile media and volatile media. Non-volatile media includes, for example, optical or magnetic disks, such as static storage 804 or dynamic storage 806. Volatile media includes dynamic memory, such as memory 802.

Computing system 800 may transmit and receive messages, data, and instructions, including program, e.g., application code, through communications link 818 and communications interface 816. Received program code may be executed by processor 808 as it is received, and/or stored in static storage 804 or dynamic storage 806, or other storage for later execution. A database 814 may be used to store data accessible by the computing system 800 by way of data interface 812. In various examples, communications link 818 may communicate with the delivery system 100 or other systems described herein.

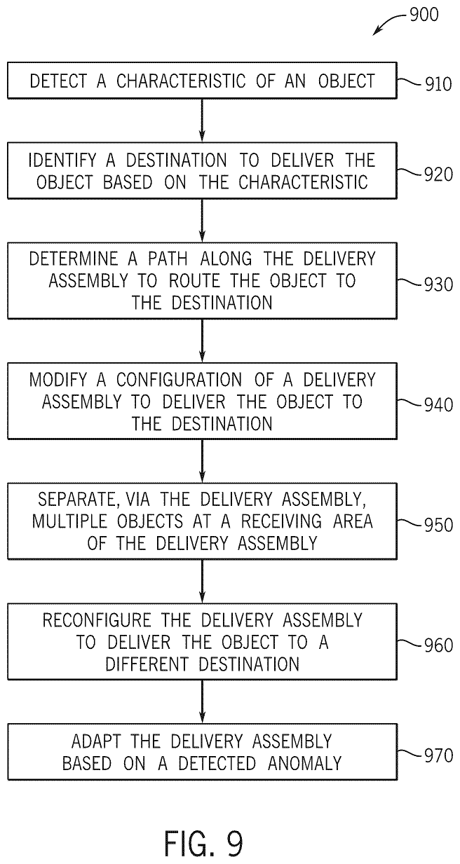

Turning to FIG. 9, an example method 900 for delivering an object (e.g., object 204) to a destination 208 as described herein is depicted. The method 900 may be implemented using the various systems described herein, such as the delivery system 100/200/240 or the computing system 800 (e.g., the processor 808). At step 910, the method 900 includes detecting a characteristic of an object (e.g., object 204). For example, a barcode, QR code, visual identifier, or other characteristic of the object 204 may be detected using the image system 218 (e.g., sensor 108), such as in a manner as described above.

At step 920, the method 900 includes identifying a destination 208 to deliver the object 204 based on the characteristic. For example, the characteristic may indicate a delivery location, such as via querying a database or as indicated by the detected characteristic itself (e.g., labeled, etc.). In some examples, the destination 208 may be identified based on a detected size or weight of the object 204, or via grouping like objects 204 together at the same destination 208.

At step 930, the method 900 may include determining a path along the delivery assembly 104 to route the object 204 to the destination 208. For example, a best route may be calculated for efficiency or increased throughput of the delivery system 100, to avoid congestion along highly utilized paths, to account for other objects 204 en route to their respective destinations 208, or the like, such as in a manner as described herein.

At step 940, the method 900 includes modifying a configuration of a delivery assembly (e.g., delivery assembly 104) to deliver the object 204 to the destination 208 via the delivery assembly 104. For example, rotating segments of the delivery assembly 104, such as the disk assemblies 330 of the support surface 246, may be driven to rotate, with rotation of the disk assemblies 330 moving the objects 204 along the support surface 246 to their respective destinations 208. In this manner, step 940 may include delivering the object 204 to the destination 208, such as along the path determined in step 930. Multiple objects 204 may be moved sequentially or simultaneously, such as along parallel or non-parallel paths along the support surface 246, such as in a manner as described herein.

The method 900 may include one or more optional steps, such as steps 950, 960, and 970 illustrated in FIG. 9. At step 950, the method 900 may include separating, via the delivery assembly 104, multiple objects 204 at a receiving area of the delivery assembly 104. For instance, the delivery assembly 104 may pull apart piles or clumps of objects 204 placed at the starting location 216 (e.g., using disk assemblies 330 to actively spread out the objects 204), such as to facilitate identification of the objects 204 using the image system 218, as described above. Step 950 may be performed prior to any of the method steps described herein.

At step 960, the method 900 includes reconfiguring the delivery assembly 104 to deliver the object 204 to a different destination 208, such as based on a user input at the destination 208. For example, user input at the destination 208 may indicate that the object 204 is not desired or otherwise rejected, whereupon the delivery assembly 104 may direct the rejected object 204 to a different destination 208, such as reversing course back to the starting location 216, to a staging area for further inspection, or the like.

At step 970, the method 900 includes adapting the delivery assembly 104 based on a detected anomaly, such as of the delivery assembly 104. For example, the image system 218 or other systems of the delivery system 100 may detect congestion or other route anomalies along the various routes 220 or paths. In such examples, the delivery assembly 104 may adapt to direct the objects 204 along a different path, such as routing the objects 204 around congestion, adjusting the routing based on demand, adjusting the routing based on changes in destination 208 (e.g., updated travel information), etc. Step 970 may be performed prior to other method steps described herein. For example, step 970 may be performed after steps 930, 940, or 950, as opposed to after 960.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system comprising:
an assembly comprising at least one modular tile forming a support surface, wherein each modular tile comprises rotating segments configured to move independently to induce a motion for an object in contact with the support surface, the assembly comprising multiple destinations defining areas for delivery; and
a processor configured to:
detect a characteristic of the object;
identify a destination of the multiple destinations to deliver the object based on the characteristic; and
modify a configuration of the rotating segments to direct the object to the destination.

2. The system of claim 1, wherein the assembly comprises a starting location and a bi-directional path between the starting location and the destination, and wherein the processor is configured to direct the object along the bi-directional path via the assembly.

3. The system of claim 1, wherein the characteristic comprises a size of the object, a weight of the object, or an identifier affixed to the object.

4. The system of claim 1, further comprising an image system configured to capture an image of the object.

5. The system of claim 1, wherein the assembly defines multiple paths to the destination, and wherein the processor is configured to select a path of the multiple paths based on the characteristic.

6. The system of claim 5, wherein the multiple paths are parallel paths.

7. The system of claim 1, wherein the support surface defines a floor for a warehouse or a factory.

8. The system of claim 1, wherein the object is a package.

9. A delivery system comprising:
a delivery assembly comprising at least one modular tile forming a support surface, wherein each modular tile comprises rotating segments configured to move independently to induce a motion for an object in contact with the support surface;
an image system configured to capture an image of the object; and
a controller configured to:
receive the image;
identify a destination to deliver the object based on the image; and
modify a configuration of the rotating segments to direct the object to the destination via the delivery assembly.

10. The delivery system of claim 9, wherein:
the delivery assembly defines a receiving area configured to receive multiple objects including the object;
the image system is configured to capture a respective image of the multiple objects; and
the controller is configured to identify respective destinations of the multiple objects, with the delivery assembly routing the multiple objects to the respective destinations.

11. The delivery system of claim 10, wherein the controller is configured to modify the configuration of the rotating segments at the receiving area to separate the multiple objects for detection.

12. The delivery system of claim 10, wherein the controller is configured to modify the configuration of the rotating segments at the receiving area to orient the multiple objects for image capture.

13. The delivery system of claim 9, wherein the controller is configured to modify the configuration of the rotating segments to direct the object to a different destination based on a user input at the destination.

14. A warehouse comprising the delivery system of claim 9.

15. An assembly line comprising the delivery system of claim 9.

16. A method for delivering an object to a destination using a delivery assembly comprising at least one modular tile connected to form a support surface, wherein each modular tile comprises rotating segments configured to move independently to induce a motion for the object in contact with the support surface, the method comprising:
detecting a characteristic of the object;
identifying the destination to deliver the object based on the characteristic; and
modifying a configuration of the rotating segments to deliver the object to the destination via the delivery assembly.

17. The method of claim 16, further comprising determining a path along the delivery assembly to route the object to the destination.

18. The method of claim 16, further comprising separating, via the delivery assembly, multiple objects including the object at a receiving area of the delivery assembly.

19. The method of claim 16, further comprising reconfiguring the delivery assembly to deliver the object to a different destination based on a user input at the destination.

20. The method of claim 16, wherein modifying the configuration of the rotating segments comprises adapting the delivery assembly to switch from a first path to the destination to a second path to the destination for the object based on a priority of the object or an anomaly along the first path.

21. The system of claim 1, wherein the processor is configured to selectively actuate the rotating segments to move independently to direct the object to the destination.

22. The system of claim 1, wherein the at least one modular tile comprises a plurality of modular tiles connected to form the support surface.
